(19) United States
(12) Patent Application Publication
(10) Pub. No.: US 2007/0129463 A1
(43) Pub. Date: Jun. 7, 2007

(54) Pigment-based ink formulations including dispersants and binders and methods of making same

(76) Inventors: Zeying Ma, San Diego, CA (US); Gregg A. Lane, San Diego, CA (US); John M. Gardner, Virginia Beach, VA (US); Howard Doumaux, San Diego, CA (US); Anne M. Kelly-Rowley, San Diego, CA (US); Peter C. Morris, San Diego, CA (US); David M. Mahli, San Diego, CA (US); Shunqiong Yue, San Diego, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/294,042

(22) Filed: Dec. 5, 2005

(51) Int. Cl. C09D 11/00

(52) U.S. Cl. 523/160; 523/161

(57) ABSTRACT

Briefly described, embodiments of this disclosure include ink formulation and encapsulated pigments. One exemplary ink formulation includes an aqueous vehicle; a pigment dispersed throughout the aqueous vehicle, the pigment having styrene-acrylic copolymeric resins encapsulating the pigment; and at least one styrene-acrylic copolymeric binder dispersed throughout the aqueous vehicle.

### BACKGROUND

The use of inkjet printing systems in offices and homes has grown dramatically in recent years. The growth can be attributed to drastic reductions in cost of inkjet printers and substantial improvements in print resolution and overall print quality. While the print quality has drastically improved, research and development efforts continue toward improving the permanence of inkjet images because this property still falls short of the permanence produced by other printing and photographic techniques. A continued demand in inkjet printing has resulted in the need to produce images of high quality, high permanence, and high durability, while maintaining a reasonable cost.

Dye-based inkjet image on photo media has reached silver halide (AgX) image quality. However, as the desirability of image permanence and durability increases, pigmented ink becomes an obvious choice, particularly for high-speed printing and porous glossy media. Image quality, thermal inkjet (TIJ) pen reliability, and rub resistance, however, can be challenges encountered with pigmented ink. Image quality defects can include low gloss, poor gloss uniformity, high haze, bronzing, coalescence, and low color gamut on plain paper. Pen reliability issues can include capped storage time, the ability of the pen to remain clear of plugs of ink in the nozzles (“decap”), bubble-induced nozzle out, resistor life, and kogation. Rub resistance can also be a challenge with pigmented inks because the pigment rests on top of a media surface, unlike dye-based inks that can penetrate into a media coating layer.

However, there is still a need for pigment-based ink having stability, low viscosity, and compatibility with multiple solvents and paper types, as well as being able to produce images of high gloss, uniform area fill, and reduced graininess.

### BRIEF DESCRIPTION OF THE DRAWINGS

Many aspects of this disclosure can be better understood with reference to the following drawings. The components in the drawings are not necessarily to scale.

FIG. 1 is a schematic view of an embodiment of the ink composition of the present disclosure.

FIG. 2 is a schematic view of an embodiment of the ink composition disposed on a substrate.

### DETAILED DESCRIPTION

It has been fortuitously and unexpectedly discovered that novel ink compositions according to embodiments of the present disclosure advantageously exhibit desirable properties such as low viscosity, better decap, and superior bubble tolerance. In addition, encapsulated pigments, formulations, and methods of making encapsulated pigments and formulations are described. Exemplary embodiments of the disclosed encapsulated pigments, when used in ink formulations, produce images of high gloss, gloss uniformity, uniform area fill, and/or reduced graininess. Embodiments of the disclosed encapsulated pigment/binder systems have high stability and low viscosity, are bleed-free and coalescence-free, and are compatible with multiple solvent and paper types as compared to other pigment systems.

The disclosed ink formulations include dispersions of pigmented ink that include at least one polymeric encapsulating dispersing agent (dispersant) for the pigment, and at least one binder in an aqueous vehicle. The pigment used can include black, cyan, magenta, and yellow; as well as other colors. The dispersant can be a copolymer having the same chemical structure as the binder, but can differ from the binder in the exact ratio of the monomers, molecular weight, and acid number.

The dispersant can be, for example, a styrene-acrylic copolymer as encapsulation resin. The glass transition temperature, molecular weight, and acid number of the resin are designed in such a way that tight encapsulation is realized. The tight encapsulation provides the pigment ink with low viscosity, improved cap results, and superior bubble tolerance. The encapsulating resin, or encapsulant, is physically adsorbed onto the pigment. The encapsulant prefers binding in some manner to the pigment, rather than binding to itself or simply existing in solution.

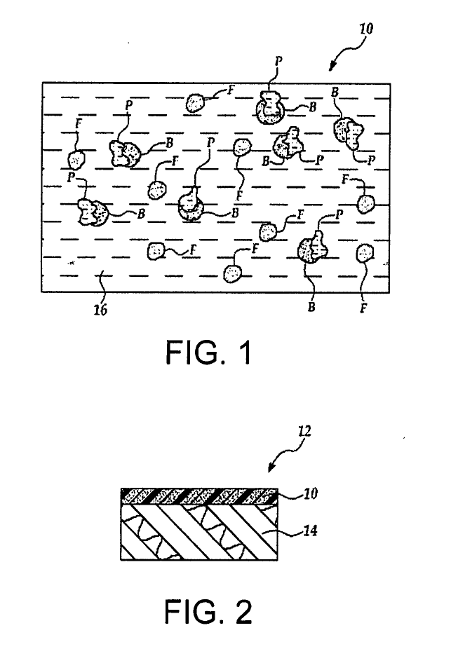

As shown in FIG. 1, embodiments of the ink composition 10 include both polymeric encapsulants B encapsulating a pigment P and polymeric binders F dispersed throughout a vehicle 16. In one embodiment, the polymeric binders F are free polymeric binders that are not encapsulating the pigment P. It is contemplated that the viscosity of the ink composition 10 can be lowered when the polymeric encapsulants B and free polymeric binders F are chemically similar. Without being bound to any theory, it is believed that this reduction in viscosity can be due in part to the addition of the chemically similar free polymeric binders F, which can substantially reduce electrostatic and/or electrosteric interactions between the encapsulant B and the vehicle 16.

As used herein, “aqueous vehicle” refers to the vehicle 16 in which pigment/colorant P is placed to form an ink composition 10. Ink vehicles are known in the art, and a wide variety of ink vehicles can be used with embodiments of the compositions, systems and methods of the present disclosure. Such aqueous vehicles 16 can include solvents, including but not limited to glycols, amides, pyrrolidones, and/or the like, and/or mixtures thereof in amounts ranging between about 0.01 and 20 wt %; alternately, between about 0.01 and 7 wt %; or between about 0.01 and 4 wt %. Aqueous vehicles 16 can also optionally include one or more water-soluble surfactants/amphiphiles in amounts ranging between about 0 and 5 wt %; alternately, between about 0.1 and 2 wt %. The balance of the aqueous vehicle 16 is generally water in embodiments of the present disclosure.

In embodiments of the ink composition 10, one or more co-solvents can be added to the aqueous vehicle 16 in the formulation of the ink composition 10. Examples of suitable classes of co-solvents include, but are not limited to, aliphatic alcohols, aromatic alcohols, diols, caprolactams, lactones, formamides, acetamides, long chain alcohols, and mixtures thereof. Examples of suitable co-solvent compounds include, but are not limited to, primary aliphatic alcohols of 30 carbons or fewer, primary aromatic alcohols of 30 carbons or fewer, secondary aliphatic alcohols of 30 carbons or fewer, secondary aromatic alcohols of 30 carbons or fewer, 1,2-alcohols of 30 carbons or fewer, 1,3-alcohols of 30 carbons or fewer, 1,5-alcohols of 30 carbons or fewer, N-alkyl caprolactams, unsubstituted caprolactams, substituted formamides, unsubstituted formamides, substituted acetamides, unsubstituted acetamides, and mixtures thereof.

Some specific suitable examples of co-solvents include, but are not limited to 1,5-pentanediol, 2-pyrrolidone, 1,2-hexanediol, 2-ethyl-2-hydroxymethyl-1,3-propanediol, diethylene glycol, 3-methoxybutanol, 1,3-dimethyl-2-imidazolidinone, and mixtures thereof. The co-solvent concentration can range between about 0.01 wt. % and 50 wt. %. In an embodiment, the co-solvent concentration ranges between about 0.1 wt. % and 20 wt. %.

In embodiments of the ink composition 10 of the present disclosure wherein water-soluble surfactants are added to the aqueous vehicle, it is to be understood that these surfactants can be added as free components to the ink composition 10 and are not otherwise associated or intended to become part of the encapsulants B/free binders F described herein. Non-limiting examples of suitable surfactants include fluorosurfactants, non-ionic surfactants, amphoteric surfactants, ionic surfactants, and/or mixtures thereof.

Examples of suitable surfactants include, but are not limited to the following commercially available trademarks: ZONYL® (fluorosurfactants), available from E.I. du Pont de Nemours and Co. located in Wilmington, Del. and TERGITOL® (alkyl polyethylene oxides), available from Union Carbide in Piscataway, N.J.

Examples of amphiphiles/surfactants that can be used in embodiments of the present disclosure include, but are not limited to iso-hexadecyl ethylene oxide 20 and amine oxides, such as N,N-dimethyl-N-dodecyl amine oxide, N,N-dimethyl-N-tetradecyl amine oxide, N,N-dimethyl-N-hexadecyl amine oxide, N, N-dimethyl-N-octadecyl amine oxide, N,N-dimethyl-N-(Z-9-octadec-enyl)-N-amine oxide, and mixtures thereof. The concentration of the amphiphiles/ surfactants can range between about 0 wt. % and 5 wt. %. In an embodiment, the concentration of amphiphiles/surfactants ranges between about 0.1 wt. % and 2 wt. %.

It is to be understood that various types of additives can be employed in the ink composition 10 according to embodiments of the present disclosure to optimize the properties of the ink composition 10 for specific applications. For example, biocides can be used in an embodiment of the ink composition 10 to inhibit growth of microorganisms. One suitable non-limiting example of a biocide is commercially available under the trademark PROXEL® GXL (1,2-benzisothiazolin-3-one) from Avecia Inc. located in Wilmington, Del. Sequestering agents such as EDTA can be included to substantially eliminate potential deleterious effects of heavy metal impurities (if any). Buffer solutions can be used to control the pH of the ink composition 10, as desired and/or necessitated by a particular end use.

The ink composition 10 according to embodiments of the present disclosure includes pigment P dispersed throughout the aqueous vehicle 16. It is to be understood that any suitable pigment P that is capable of having polymeric encapsulants B (also referred to as “dispersant”) encapsulating the pigment P, can be used. Non-limiting examples of some suitable polymers B encapsulating pigments P, and methods of encapsulating the pigments P used in aqueous ink dispersions are described in Japanese Laid-Open Publication Nos. 2005-060431, 2005-060419, 2005-060411, 2005-048014, 2004-143316, 2004-091590, 2004-083893, 2004-051777, 2003-226832, and 2003-226831, the disclosures of each of which are incorporated herein by reference in their entireties.

The attached polymeric resins B (“dispersant” or “encapsulant”) can be selected using a variety of parameters including, but not limited to molecular weight, acid number, and/or the type of monomers within the polymeric resin B. In one embodiment, the molecular weight of the encapsulating polymeric resins B ranges from about 2,000 to about 20,000, or from about 8,000 to 11,000. In another embodiment, the acid number of the encapsulating polymeric resins B can range from about 50 to about 250, or from about 120 to about 200, or from about 155 to about 185. Examples of suitable monomers within the polymeric encapsulants B include, but are not limited to styrene, acrylic acid, substituted acrylic acids, maleic anhydride, and/or substituted maleic anhydrides. In addition, the pigment P can include pigments such as those described in more below.

Some non-limiting examples of polymeric encapsulants B capable of encapsulating the pigment P are styrene-acrylic resins/polymers/copolymers, styrene-maleic anhydride resins/polymers/copolymers, and combinations thereof. Some suitable styrene-acrylic resins/polymers/copolymers are commercially available under the trademarks JONCRYL® 586 (J586), JONCRYL 671 (J671), JONCRYL 683 (J683), and JONCRYL 696 (J696) from Johnson Polymer, Inc. located in Sturtevant, Wis., and SMA (Styrene Maleic Anhydride) polymers available from Sartomer located in Exton, Pa.

In an embodiment, the pigment P having polymeric resins B encapsulating the pigment P is present in an amount ranging from about 0.1 wt. % to 10 wt. % of the ink composition, or from about 0.5 to 10 wt. % of the ink composition, or from about 0.7 to 2 wt. %, or from about 1 wt. % to about 2 wt. %. In an alternate embodiment, the pigment P having polymeric resins B encapsulating the pigment P is present in an amount ranging between about 0.5 wt. % and 7 wt. % of the ink composition.

An embodiment of the ink composition 10 (FIG. 1) further includes at least one free polymeric binder F dispersed throughout the aqueous vehicle 16. It is to be understood that the free polymeric binders F can be substantially homogeneously and/or non-homogeneously mixed throughout the aqueous vehicle 16. In an embodiment, the free polymeric binders F are present in an amount ranging between about 0.1 wt. % and 6 wt. % of the ink composition. In an alternate embodiment, the free polymeric binders F are present in an amount ranging between about 0.5 wt. % and 10 wt. %, or between about 1 wt. % and 3 wt. % of the ink composition 10.

In an embodiment of the ink composition 10 of the present disclosure, selected free polymeric binders F are formed from a polymeric material that is chemically similar to the selected encapsulating polymeric resins B. “Chemically similar” as defined herein denotes compounds that have the same or similar molecular weight, acid number, and/or monomer composition. It is to be understood that “similar” in regard to molecular weights as defined herein is contemplated to encompass compounds having molecular weights ranging from about 2,000 to about 20,000, or from about 5,000 to about 15,000, or from about 8,000 to about 11,000. In one exemplary embodiment, the encapsulating polymer B has a higher molecular weight than the free polymer F.

Similar to the polymeric encapsulants B, in an embodiment of the ink composition 10, the molecular weight of the free polymeric binders F ranges from about 2,000 to about 20,000, or from about 5,000 to about 15,000, or from about 8,000 to about 11,000. In one embodiment, the acid number of the free polymeric binders F ranges from about 50 to 250, or from about 120 to 200, or from about 155 to 185. Non-limiting examples of suitable free polymeric binders F include the styrene-acrylic resins/polymers as previously described in reference to the polymeric encapsulants B.

It is believed, without being bound to any theory, that when the free polymeric binders F and the polymeric encapsulants B are chemically similar, the electrostatic and/or electrosteric interactions between the polymeric encapsulants B and the aqueous vehicle 16 can be substantially reduced. This reduction can advantageously help to lower the viscosity of the ink composition 10. The viscosity of the ink composition 10 of the present disclosure ranges from about 1 centipoise (cps) to 15 cps, or from about 2 cps to about 10 cps. In an alternate embodiment, the viscosity of the ink composition 10 of the present disclosure ranges from about 2 cps to 8 cps, or from about 3 to 4.5 cps. The reduced viscosity of the ink composition 10 can advantageously help to improve ink reliability, ink durability, and print quality.

FIG. 2 illustrates an embodiment of the ink composition 10 deposited on a substrate 14. It is to be understood that the ink composition 10 can be deposited on the substrate 14 using any suitable printing technique, such as an ink jet printer. Examples of suitable substrate 14 materials include, but are not limited to cellulosic materials (e.g., paper materials), wood, textile materials, polymeric materials, metals, and/or mixtures thereof.

In a method of making an embodiment of the ink composition 10, an amount of the pigment P having polymeric encapsulants B is admixed in a selected aqueous vehicle 16 to form an ink fluid. Further, at least one free polymeric binder F can be admixed with the ink fluid to form the ink composition 10. It is to be understood that the materials described above can be selected and that the polymeric encapsulants B are substantially chemically similar to the free polymeric binders F.

The pigment can include, but is not limited to, black pigment-based inks and colored pigment-based inks. Colored pigment-based inks can include, but are not limited to, blue, brown, cyan, green, white, violet, magenta, red, orange, yellow, as well as mixtures thereof.

The following black pigments can be used in the practice of this disclosure; however, this listing is merely illustrative and not intended to limit the disclosure. The following black pigments are available from Cabot: Monarch™ 1400, Monarch™ 1300, Monarch™ 1100, Monarch™ 1000, Monarch™ 900, Monarch™ 880, Monarch™ 800, and Monarch™ 700, Cab-O-Jet™ 200, Cab-O-Jet™ 300, Black Pearls™ 2000, Black Pearls™ 1400, Black Pearls™ 1300, Black Pearls™ 1100, Black Pearls™ 1000, Black Pearls™ 900, Black Pearls™ 880, Black Pearls™ 800, Black Pearls™ 700; the following are available from Columbian: Raven 7000, Raven 5750, Raven 5250, Raven 5000, and Raven 3500; the following are available from Degussa: Color Black FW 200, Color Black FW 2, Color Black FW 2V, Color Black FW 1, Color Black FW 18, Color Black S 160, Color Black FW S 170, Special Black 6, Special Black 5, Special Black 4A, Special Black 4, Printex U, Printex 140U, Printex V, and Printex 140V.

The pigment can also be chosen from a wide range of conventional colored pigments. For the purposes of clarification only, and not for limitation, some exemplary colorants suitable for this purpose are set forth below. Suitable classes of colored pigments include, for example, anthraquinones, phthalocyanine blues, phthalocyanine greens, diazos, monoazos, pyranthrones, perylenes, heterocyclic yellows, quinacridones, and (thio)indigoids. Representative examples of phthalocyanine blues include copper phthalocyanine blue and derivatives thereof (Pigment Blue 15). Representative examples of quinacridones include Pigment Orange 48, Pigment Orange 49, Pigment Red 122, Pigment Red 192, Pigment Red 202, Pigment Red 206, Pigment Red 207, Pigment Red 209, Pigment Violet 19 and Pigment Violet 42. Representative examples of anthraquinones include Pigment Red 43, Pigment Red 194 (Perinone Red), Pigment Red 216 (Brominated Pyanthrone Red) and Pigment Red 226 (Pyranthrone Red). Representative examples of perylenes include Pigment Red 123, Pigment Red 149, Pigment Red 168 (dibromoanthanthrone available from Clariant as Scarlet GO), Pigment Red 179, Pigment Red 190, Pigment Violet 19, Pigment Red 189 and Pigment Red 224. Representative examples of thioindigoids include Pigment Red 86, Pigment Red 87, Pigment Red 88, Pigment Red 181, Pigment Red 198, Pigment Violet 36, and Pigment Violet 38. Representative examples of heterocyclic yellows include Pigment Yellow 1, Pigment Yellow 3, Pigment Yellow 12, Pigment Yellow 13, Pigment Yellow 14, Pigment Yellow 17, Pigment Yellow 65, Pigment Yellow 73, Pigment Yellow 74, Pigment Yellow 151, Pigment Yellow 117, Pigment Yellow 128, Pigment Yellow 138, and Yellow Pigment 155.

Such pigments are commercially available in either powder or press cake form from a number of sources including, BASF Corporation, Engelhard Corporation and Sun Chemical Corporation. Examples of other suitable colored pigments are described in the Colour Index, 3rd edition (The Society of Dyers and Colourists, 1982).

Other examples of pigments include Hostafinet series such as Pigment 13, Pigment 83, Pigment Red 9, Pigment 184, Pigment Blue 15:3, Pigment Black 7, and Pigment Black 7, available from Hoechst Celanese Corporation, Normandy Magenta RD-2400 (Paul Uhlich), Paliogen Violet 5100 (BASF), Paliogen™ Violet 5890 (BASF), Permanent Violet VT2645 (Paul Uhlich), Heliogen Green L8730 (BASF), Argyle Green XP-111-S (Paul Uhlich), Brilliant Green Toner GR 0991 (Paul Uhlich), Heliogen™ Blue L6900, L7020 (BASF), Heliogen™ Blue D6840, D7080 (BASF), Sudan Blue OS (BASF), PV Fast Blue B2GO1 (American Hoechst), Irgalite Blue BCA (Ciba-Geigy), Paliogen™ Blue 6470 (BASF), Sudan III (Matheson, Coleman, Bell), Sudan II (Matheson, Coleman, Bell), Sudan IV (Matheson, Coleman, Bell), Sudan Orange G (Aldrich), Sudan Orange 220 (BASF), Paliogen™ Orange 3040 (BASF), Ortho Orange OR 2673 (Paul Uhlich), Paliogen™ Yellow 152, 1560 (BASF), Lithol Fast Yellow 0991K (BASF), Paliotol Yellow 1840 (BASF), NovoperM™ Yellow FG 1 (Hoechst), Permanent Yellow YE 0305 (Paul Uhlich), Lumogen Yellow D0790 (BASF), Suco-Gelb L1250 (BASF), Suco-Yellow D1355 (BASF), Hostaperm™ Pink E (American Hoechst), Fanal Pink D4830 (BASF), Cinquasia Magenta (DuPont), Lithol Scarlet D3700 (BASF), Toluidine Red (Aldrich), Scarlet for Thermoplast NSD PS PA (Ugine Kuhlmann of Canada), E.D. Toluidine Red (Aldrich), Lithol Rubine Toner (Paul Uhlich), Lithol Scarlet 4440 (BASF), Bon Red C (Dominion Color Company), Royal Brilliant Red RD-8192 (Paul Uhlich), Oracet Pink RF (Ciba-Geigy), Paliogen™ Red 3871K (BASF), Paliogen™ Red 3340 (BASF), Lithol Fast Scarlet L4300 (BASF) ,and Tipure™ available from DuPont.

To further illustrate the present disclosure, the following examples of ink formulations and binder formulations are given. It is to be understood that these examples are provided for illustrative purposes and are not to be construed as limiting the scope of the present disclosure to the specific formulations recited herein.

### EXAMPLES

Tables 1-3 illustrate various examples of the ink composition 10 and encapsulant B, according to embodiments of the present disclosure. Table 1 below presents properties such as acid number and molecular weights of illustrative encapsulants/binders of representative dispersions. The formulations of the illustrative binders are present in Table 2. Table 3 provides components of various ink formulations that include the encapsulants/binders of Tables 1 and 2. It should be noted that the Dispersion Identification (ID) Nos. and Resin ID Nos. utilized in the tables are numbers that are used to correlate the dispersions and binders used in the representative formulations. The term “Acid No.” refers to amount (in mg) of base (KOH) to neutralize 1 g of the polymeric binder. In each of the Tables, K=Black; C=Cyan; M=Magenta; Y=Yellow; V=Violet. The values given in the Tables, e.g., glass transition temperature values are approximate.

TABLE 1
Pigment Encapsulation

| | K | C | M | Y | V |
|---|---|---|---|---|---|
| Disp. ID No. | 1 | 2 | 10 | 11 | 9 |
| Resin ID No. | 101 | 101 | 100 | 101 | 100 |
| Acid No. | 155 | 155 | 155 | 155 | 155 |
| Molec. Wt. | 8,000 | 8,000 | 11,000 | 8,000 | 11,000 |

TABLE 2
Example Binders ID Nos. 101-108_{[HD1]}

| | | | Acid | |
|---|---|---|---|---|
| Binder | | | Number | Tg** |
| ID No. | Composition | Mw | mgKOH/g | ° C. |
| 100 | St/AA/MAA = 77/10/13: Basic | 11700 | 153 | 121 |
| | Composition | | | |
| 101 | (weight ratio of monomer | 8600 | 152 | 117 |
| | composition) | | | |
| 102 | St: increased, AA and MAA: | 10850 | 133 | |
| | decreased | | | |
| 103 | | 10800 | 121 | |
| 104 | St: decreased, AA and MAA: | 11400 | 200 | |
| | increased | | | |
| 105 | Branch Type: 1% DVB included | 30800 | 153 | 126 |
| 106 | Branch Type: 3% DVB included | 40800 | 151 | 123 |
| 107 | St: decreased to 25%, 52% MMA | 11900 | 122 | 118 |
| | added | | | |
| 108 | St: decreased to 50%, 27% BA | 10400 | 154 | 73 |
| | added | | | |

St: styrene
MAA: methacrylic acid
BA: butyl acrylate
AA: acrylic acid
MMA methyl methacrylate
DVB: di-vinylbenzene
**measured by DSC

TABLE 3
Example Ink Formulations

| | Ink | | | | |
|---|---|---|---|---|---|
| | Photo | Light | | | |
| | Black | Gray | Magenta | Yellow | Cyan |
| Magenta Disp. ID No. 10 | | | ✓ | | |
| Cyan Disp. ID No. 2 | ✓ | ✓ | | | ✓ |
| Black Disp. ID No. 1 | ✓ | ✓ | | | |
| Yellow Disp. ID No. 11 | | | | ✓ | |
| Violet Disp. ID No. 9 | ✓ | ✓ | | | |
| Binder | ✓ | | | ✓ | ✓ |
| Joncryl ® 683 | | ✓ | ✓ | | |
| Biocide | ✓ | ✓ | ✓ | ✓ | ✓ |
| Diethylene glycol | ✓ | ✓ | ✓ | ✓ | ✓ |
| Ethoxylated GLycerol | ✓ | ✓ | ✓ | ✓ | ✓ |
| 2-Pyrrolidone | ✓ | ✓ | ✓ | ✓ | ✓ |
| Glycerol | ✓ | ✓ | ✓ | ✓ | ✓ |
| 1,2 Hexanediol | ✓ | ✓ | ✓ | ✓ | ✓ |
| Ethoxylated Acetylenic | ✓ | ✓ | ✓ | ✓ | ✓ |
| Diol | | | | | |
| Flurosurfactant | ✓ | ✓ | ✓ | ✓ | ✓ |
| TEA | ✓ | | ✓ | | |
| Surfactant | ✓ | ✓ | ✓ | | |
| Buffer | | ✓ | ✓ | | |
| Hexamethylenediaminetetra | | | | | ✓ |
| (methylenephosphonic | | | | | |
| acid) | | | | | |
| Water | ✓ | ✓ | ✓ | ✓ | ✓ |

The disclosed encapsulation resins provide a low viscosity ink dispersion to which a binder can be added. The viscosity ranges from about 3 to 4.5 centipoise. The dispersion is stable to 1,2-hexanediol, which increases the performance of the ink. By using a styrene with a higher glass transition temperature, as indicated in Table 2 performance is improved. In addition, the disclosed pigments exhibit minimal particle growth at ambient storage, in a conventional accelerated shelf life study at 60° C., or in T-cycle testing conditions.

It should be noted that ratios, concentrations, amounts, and other numerical data can be expressed herein in a range format. It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a concentration range of “about 0.1% to about 5%” should be interpreted to include not only the explicitly recited concentration of about 0.1 wt % to about 5 wt %, but also include individual concentrations (e.g., 1%, 2%, 3%, and 4%) and the sub-ranges (e.g., 0.5%, 1.1%, 2.2%, 3.3%, and 4.4%) within the indicated range.

Many variations and modifications can be made to the above-described embodiments. All such modifications and variations are intended to be included herein within the scope of this disclosure and protected by the following claims.

The following is claimed:

1. An ink composition, comprising:
an aqueous vehicle;
a pigment dispersed throughout the aqueous vehicle, the pigment having encapsulating resins, the encapsulating resins selected from the group consisting of styrene acrylic copolymer, styrene-maleic anhydride copolymer and combinations thereof; and
at least one binder dispersed throughout the aqueous vehicle, the binder selected from the group consisting of styrene acrylic copolymer, styrene-maleic anhydride copolymer and combinations thereof;
wherein the ink composition has a viscosity of about 1 cps to about 15 cps; and wherein the ink composition is stable to 1,2-hexane diol.

2. The ink composition of claim 1, wherein the encapsulating resin and the binder are styrene-acrylic copolymers.

3. The ink composition of claim 1, wherein the styrene-acrylic copolymeric binder dispersed throughout the aqueous vehicle is a free polymeric binder.

4. The ink composition of claim 1, wherein the encapsulating resin has a higher molecular weight than the styrene-acrylic copolymeric binder dispersed throughout the aqueous vehicle.

5. The ink composition of claim 1, wherein the encapsulating resins and the polymeric binder has a molecular weight ranging from about 2,000 to about 20,000.

6. The ink composition of claim 1, wherein the encapsulating resins and the polymeric binder has a molecular weight ranging from about 5,000 to about 15,000.

7. The ink composition of claim 1, wherein the encapsulating resins and the polymeric binder has a molecular weight ranging from about 8,000 to about 11,000.

8. The ink composition of claim 1, wherein the encapsulating resins and the polymeric binder have an acid number ranging from about 50 to about 250.

9. The ink composition of claim 1, wherein the encapsulating resins and the polymeric binder has an acid number ranging from about 120 to about 225.

10. The ink composition of claim 1, wherein the encapsulating resins and the polymeric binder has an acid number ranging from about 120 to about 185.

11. The ink composition of claim 1, wherein the encapsulating resins and the polymeric binder has an acid number ranging from about 155 to about 185.

12. The ink composition of claim 1, wherein the ink composition has a viscosity ranging between about 2 cps and about 8 cps.

13. The ink composition of claim 1, wherein the ink composition has a viscosity ranging between about 3 cps and about 4.5 cps.

14. The ink composition of claim 1, wherein the styrene-acrylic copolymeric resins encapsulating the pigment are present in an amount ranging from about 0.5 wt. % to about 10 wt. % of the ink composition.

15. The ink composition of claim 1, wherein the styrene-acrylic copolymeric resins encapsulating the pigment are present in an amount ranging from about 0.7 wt. % to about 2 wt. % of the ink composition.

16. The ink composition of claim 1, wherein the styrene-acrylic copolymeric resins encapsulating the pigment has a glass transition temperature in the range of about 70 to 130.

17. The ink composition of claim 1, wherein the pigment exhibits minimal particle growth in at least one of the following conditions: ambient storage, accelerated shelf life study at 60 or 70° C., and T-cycle testing.
